(19) United States
(12) Patent Application Publication
(10) Pub. No.: US 2018/0285327 A1
(43) Pub. Date: Oct. 4, 2018

(54) DETERMINING CACHEABILITY OF WEBPAGES

(71) Applicants: Ziga MAHKOVEC, San Francisco, CA (US); Samarth KESHAVA, San Francisco, CA (US); Jered WIERZBICKI, San Francisco, CA (US)

(72) Inventors: Ziga MAHKOVEC, San Francisco, CA (US); Samarth KESHAVA, San Francisco, CA (US); Jered WIERZBICKI, San Francisco, CA (US)

(21) Appl. No.: 13/775,478

(22) Filed: Feb. 25, 2013

Related U.S. Application Data
(60) Provisional application No. 61/671,603, filed on Jul. 13, 2012.

(51) Int. Cl. G06F 17/22

(52) U.S. Cl. CPC G06F 17/2247

(57) ABSTRACT

Methods, systems and computer-readable storage mediums encoded with computer programs executed by one or more processors for determining cacheability of a webpage are disclosed. In an embodiment, a request for a webpage is received. A change rate associated with the webpage is determined. A cacheability determination is made as to whether the cached version of the webpage is to be provided responsive to the request based on a cached timestamp of the cached version being more recent than the change rate being subtracted from one of a current time or time at which the request was received. The cached version of the webpage is provided responsive to the request based on the cacheability determination.

### CROSS-REFERENCE TO RELATED APPLICATION

This application claims the benefit of U.S. Provisional Application No. 61/671,603, filed Jul. 13, 2012, which is hereby incorporated by reference.

### TECHNICAL FIELD

Embodiments herein relate generally to determining cacheabilty of webpages.

### BACKGROUND

With the advancement of technology and the increase in available bandwidth, users have come to expect instantaneous or near-instantaneous responsiveness from applications, including web applications and web sites. For example, a user operating a browser to view a particular webpage may select one of the webpage's hyperlinks to view a different webpage. This selection directs the browser to request the selected webpage from a network server. The user then waits until the browser receives and displays the requested webpage content.

While this process may occur relatively quickly, the process is also exposed to numerous potential sources for delays that could force the user to have to wait an extended period of time between the time the user selects a hyperlink, and the time the browser has received and is able to display the selected webpage. To counter these delays, cached versions of webpages may be provided. However, not all webpages are well-suited to be cached.

### BRIEF SUMMARY

Some aspects of the subject matter described in this specification may be embodied in a computer-implemented method. As part of the method, A change rate associated with the webpage is determined. A cacheability determination is made as to whether the cached version of the webpage is to be provided responsive to the request based on a cached timestamp of the cached version being more recent than the change rate being subtracted from one of a current time or time at which the request was received. The cached version of the webpage is provided responsive to the request based on the cacheability determination.

Other embodiments of include corresponding systems, apparatus, and computer programs, configured to perform the actions of the methods, encoded on computer storage devices. Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a block diagram illustrating a system for determining the cacheability of a webpage, according to an embodiment.

FIG. 2 is a flow chart of a process of determining the cacheability of a webpage and providing the cached webpage, according to an example embodiment.

FIG. 3 is a system diagram that can be used to embody or implement embodiments described herein.

### DETAILED DESCRIPTION

While the present disclosure makes reference to illustrative embodiments for particular applications, it should be understood that embodiments are not limited thereto. Other embodiments are possible, and modifications can be made to the embodiments within the spirit and scope of the teachings herein, and additional fields in which the embodiments would be of significant utility. Further, when a particular feature, structure, or characteristic is described in connection with an embodiment, it is submitted that it is within the knowledge of one skilled in the relevant art to affect such feature, structure, or characteristic in connection with other embodiments whether or not explicitly described.

When a user operating a browser application on a computing device, such as a laptop or mobile phone, enters a webpage or network address into the browser application, a request for the webpage is communicated over a network (e.g., the Internet) to a server hosting the webpage. The server, upon receiving the request, will provide the browser with the text, images, code, and other data necessary to render the webpage in the browser of the device. Once rendered, the user may view or otherwise interact with the webpage.

When the network or the server is offline, it may still be possible for the user to access a cached, or previously saved version, of the webpage. A cached webpage may include some or all of the data necessary for a browser to render the webpage and allow a user to view or interact with the webpage. The cached webpage may be stored on another server or device operating on the network, or may be stored locally on the computing device of the user.

However, not all webpages are cacheable, or suited to be cached. Ideally, a cached version of the webpage will resemble, or closely resemble, the most up-to-date live version of the webpage (as would be provided by the server over the network, were both operable) as would be viewed by the user requesting the webpage. So, for example, some webpages, such as news websites, change too frequently to reliably be cached. In addition to how often a webpage is updated or changed, there could be any other number of reasons why a webpage would not be cacheable. Some webpages may have information personalized based on the location of the user visiting the webpage, and thus may not be well-suited to be cached. In such circumstances, it would be undesirable to provide a cached version of the webpage as an intermediate proxy for the live version.

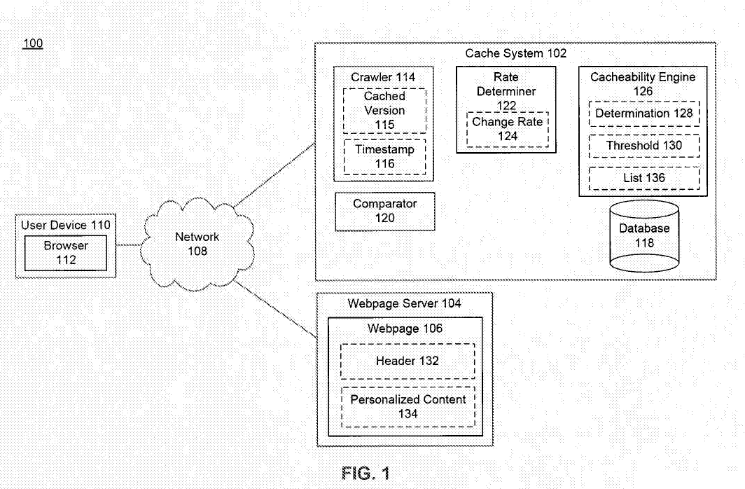

FIG. 1 is a diagram 100 illustrating a system for determining cacheability of webpages, according to an embodiment. A cache system 102 may determine the cacheability of webpages. Cache system 102 may further allow for a run-time determination to be made as to whether a previously-cached version of a webpage is recent enough to be provided to a user. As referenced above, the cacheability of a webpage may be a determination as to the likelihood that a previously saved or cached version of the webpage will be identical, or at least have a high degree of similarity, to the live version of the webpage as would be provided by a server hosting the webpage to a user device from which a request for the webpage originates. In some embodiments, the cached version of the webpage may only include portions of a webpage that are generally consistent over time, such as the logo or background of the webpage. In other embodiments, the cached version may include all the data necessary to fully-reproduce the live version of the webpage, or any variation in between. The cacheability of a webpage, however, may be based on any number or combination of factors.

Cache system 102 may determine the cacheability of a webpage 106 as hosted or provided by webpage server 104 over a network 108. Webpage 106 may include any document or file accessible over network 108. Webpage 106 may be a portion of a related group of files or webpages that are assembled as a website. Webpage 106 may include a document object model (DOM) that includes the objects or elements that make up webpage 106. For example, webpage 106 may include text, images, multimedia, hyperlinks, particular formatting information, metadata, code, background wallpaper, and/or other objects.

Webpage server 104 may be any computing device operatively connected to network 108 that provides data for rendering or otherwise hosts webpage 106. Webpage server 104 may include a single computer, or may include a server farm, or anything in between.

Network 108 may include any communications network, including, but not limited to the Internet. Network 108 may be a wired or wireless network that transmits data between various devices communicatively coupled to the network, such as cache system 102, webpage server 104, and a user device 110.

User device 110 may be any computing device, such as a mobile phone, tablet computer, server, desktop computer, laptop computer, or other network compatible device. User device 110 can communicate over network 108 and may include a browser 112 through which a user may request and/or view webpage 106.

Browser 112, operating on user device 110, may be any application or program that allows a user to request, view or otherwise interact with webpage 106 as provided by webpage server 104 over network 108. For example, a user may enter a network address (e.g., HTTP address) in browser 112. Browser 112 may then communicate the request over network 108 to webpage server 104. Webpage server 104 may respond by providing the document(s) and/or data necessary for browser 112 to render or generate webpage 106 on user device 110.

Cache system 102 may be any device or service operating on or otherwise communicatively coupled to network 108. In an embodiment, cache system 102 may include one or more servers or other computing devices that perform a particular task. For example, cache system 102 may be a search system or search engine operating on one or more servers. In an embodiment, cache system 102 may operate on user device 110 or other device coupled to network 108.

In an embodiment, cache system 102 includes a crawler 114. Crawler 114 may be a program or application that browses or explores network 108. For example, crawler 114 may methodically or automatically crawl network 108 and store or index various webpages 106 accessible via network 108. Crawler 114 may be a bot, network spider, or other indexer.

In an embodiment, crawler 114 may request webpage 106 over network 108 from webpage server 104. Crawler 114 may then copy, save, or otherwise cache webpage 106 as provided by webpage server 104 as cached version 115. Cached version 115 may be a fully-functional version of webpage 106 as saved or cached by crawler 114. In another embodiment, cached version 115 may only include a portion of webpage 106. For example, cached version 115 may include those portion(s) of webpage 106 that are determined to be relatively static or unchanging (as will be discussed in greater detail below) over a period of time. Or, for example, cached version 115 may not include files of webpage 106 that exceed a size threshold, such as image or multimedia files that may exceed a threshold.

Crawler 114 may assign a timestamp 116 to cached version 115, and store cached version 115 with the corresponding timestamp 116 in a database 118. Timestamp 116 may indicate when webpage 106 was requested from webpage server 104, received from network 108, or cached by cache system 102. Timestamp 116 may include a date and/or time of when a version of webpage 106 was received by cache system 102. In another embodiment, webpage server 104 may assign or otherwise indicate the value of timestamp 116 for webpage 106, which may be read by crawler 114 and assigned to cached version 115.

Database 118 may by any storage device or memory. Database 118 may include one or more cached versions 115 that were stored at various times and include varying timestamps 116. In another embodiment, database 118 may include only the most recently cached version 115.

A comparator 120 may compare two or more cached versions 115 to identify any difference(s) that may exist amongst the versions of webpage 106. Comparator 120 may use various methods of comparison to determine similarities and/or differences between cached versions 115 of webpage 106. For example, comparator 120 may compare a document object model (DOM) of each cached version 115 to determine whether any differences exist amongst the versions. In an embodiment, comparator 120 may compare other aspects of cached versions 115, such as the objects contained within a cached version 115. The objects may include metadata, images, code portions, or other elements of webpage 106 as may be cached within cached version 115.

Or, for example, comparator 120 may compare a portion of the text or image(s) that appear on webpage 106 to determine similarities/differences amongst various cached versions 115. For example, comparator 120 may compare one or more words appearing at one or more locations on webpage 106 across multiple cached versions 115 and determine whether the words are identical and/or what differences exist amongst them. In an example embodiment, if webpage 106 is a news website, comparator 120 may compare the first or main headline amongst two or more cached versions 115 of the news website.

In an embodiment, comparator 120 computes a hash value for each of two or more cached versions 115, and compares the hash values. Based on the comparison of the hash values, comparator 120 may determine whether there were any differences between the two or more cached versions 115. For example, if any portion of webpage 106 has changed between when a first cached version 115 (with a first timestamp 116) was cached and when a second cached version 115 (with a second timestamp 116) was cached, the comparator 120 may determine that the hash value of each version 115 is different.

A rate determiner 122 may determine a change rate 124 for webpage 106. Change rate 124 may be an indicator for how often webpage 106, or a portion thereof, changes. For example, change rate 124 may be a specified time value (e.g., one hour) or a scaled value (e.g., between 1 and 10) indicating how often webpage 106 changes. In an embodiment, the value of change rate 124 may be based, at least in part, on how often crawler 114 caches versions of webpage 106. For example, if crawler 114 only saves a cached version 115 of webpage 106 once every three hours, then, change rate 124 may be a value on a scale of three hours.

In an embodiment, crawler 114 captures two or more cached versions 115 at a particular time apart, such as one hour. Based on an indication by comparator 120 that webpage 106 changed between the time the first version was captured and the time the second version was captured, rate determiner 122 may determine that change rate 122 is less than an hour. Rate determiner 122 may then signal crawler 114 to index subsequent cached version 115 of webpage 106 after thirty minutes (or another time interval), such that rate determiner 122 may more precisely determine change rate 124 for webpage 106.

In an embodiment, rate determiner 122 may determine change rate 124 for an entire webpage 106, or for each of multiple portions of webpage 106. For example, webpage 106 may include a background portion, a logo or header portion, a text portion, and an image portion. Then, for example, rate determiner 122 may determine a change rate 124 for one or more of the various portions. Or, for example, rate determiner 122 may determine one change rate 124 for webpage 106 which may be the weighted or unweighted average or median of the change rates 124 for the particular portions of webpage 106, the smallest change rate 124, or the change rate for any selected portion or basis of comparison of webpage 106.

Rate determiner 122 may compare various versions of webpage 106 with different timestamps 116 to determine change rate 124 for how often webpage 106, or particular portions thereof, change between cached versions 115. For example, a particular webpage that tracks the price of stocks may constantly change, because the stock prices may be continuously updated throughout the trading day. Thus, two cached versions 115 of the stock tracking webpage may be very different. Rate determiner 122 may then determine, based on comparing the various cached versions 115 of the stock tracking webpage, that the webpage changes every time a new cached version 115 is received. As such, change rate 124 may be the frequency with which crawler 114 caches webpage 106.

A cacheability engine 126 makes a cacheability determination 128 as to whether cached version 115 may be provided in response to a request for webpage 106. Cacheability engine 126 may determine, in real-time or during run-time, whether cached version 115 has been cached recently enough to be provided as user device 110. For example, cached version 115 may have or be associated with timestamp 116 which indicates when cached version 115 was cached. If timestamp 116 is less than the current time or time at which the request for webpage 106 was received minus change rate 124 for webpage 106, then cacheability engine 126 may determine that cached version 115 may be provided in response to the request.

The cacheability engine 126 may also make cacheability determination 128 as to whether or not webpage 106 is cacheable. Cacheability engine 126 may make determination 128 based on any number of factors. For example, cacheability engine 126 may compare change rate 124 to a threshold 130 to determine whether webpage 106 is cacheable. Threshold 130 may be an indication of a maximum value that change rate 124 must be for cacheability engine 126 to make determination 128 that webpage 106 is cacheable. For example, threshold 130 may be five hours. Then for example, any webpage 106, or portion thereof, that changes more than once every five hours, cacheability engine 126 will determine (e.g., through determination 128) to be uncacheable.

Cacheability engine 126 may also make determination 128 based on other factors, such as metadata or other information contained in the webpage that indicates whether the webpage is cacheable. For example, webpage 106 may include a header 132 that indicates whether or not webpage 106 is cacheable. Header 132 may be a HTTP (hyper text transfer protocol) header, metadata, or other code that includes an indication as to whether or not webpage 106 is cacheable. Header 132 may include any combination of cacheability data such as whether or not webpage 106 is cacheable, who it is cacheable by, and other indications of cacheability.

In an embodiment, cacheability engine 126 may make determination 128 based on the indication of header 132. For example, even if change rate 124 for webpage 106 is within threshold 130, cacheability engine 126 may nonetheless determine that webpage 106 is not cacheable if header 132 indicates that webpage 106 is not cacheable. In another embodiment, however, cacheability engine 126 may override the indication (if any) of header 132. For example, if header 132 indicates that webpage 106 is not cacheable or if webpage 106 does not include a field for header 132, cacheability engine 126 may override or ignore header 132 and may make determination 128 based on other factors described herein, such as the comparison of change rate 124 to threshold 130.

In an embodiment, cacheability engine 126 may make determination 128 based on whether webpage 106 includes personalized content 134. Personalized content 134 may include any content of webpage 106 that is personalized based on which user device 110 or which user is requesting webpage 106. For example, personalized content 134 may include content that is customized or personalized based on a name, location, language, device, social network, or other information or preferences of a user or user device 110 requesting webpage 106. As referenced above, cacheability engine 126 may bar or otherwise determine that webpage 106 is not cacheable based on the existence of personalized content 134 on webpage 106, even if change rate 124 is within threshold 130.

In an embodiment, it may not be desirable to cache a webpage 106 with personalized content 134, because cached version 115 may be provided to various users whose information may or may not be in accord with personalized content 134 of cached version 115. For example, webpage 106 may include personalized content 134 based on the city or location of a particular user. Cache system 102 would not want to provide cached version 115 with personalized content 134 of a user in city A to a different user in city B, and thus may make determination 128 that webpage 106 having personalized content 134 is uncacheable. In another embodiment, cache system 102 may choose to cache only those portions of webpage 106 that do not include personalized content 134.

In an embodiment, cacheability engine 126 may include one or more lists 136 of which webpages or websites 106 are cacheable or not cacheable. List 136 may include an identification of which webpages 106 are (and/or are not) cacheable. For example, cacheability engine 126 may store determination 128 for different webpages 106 in list 136. When a query is made as to the cacheability of a particular webpage 106, determination 128 may be retrieved from a corresponding list 136. Or for example, based on which webpages 106 are included on list 136, crawler 114 may no longer crawl or fetch webpages 106 that are listed as being uncacheable.

In an embodiment, a user operating user device 110 may desire to view webpage 106. Cache system 102 may determine whether or not cached version 115 is available (based on determination 128) and provide cached version 115 (if available) of webpage 106 to user device 110. For example, webpage server 104 may be down (e.g., inoperable) or otherwise operating slowly, or cache system 102 may determine that providing cached version 115 would be faster than user device 110 receiving webpage 106 from webpage server 104.

As referenced above, prior to providing cached version 115 to user device 110, cacheability engine 126 may determine whether cached version 115 is still fresh or recent enough to provide to user device 110. In an embodiment, change rate 124 may already be known, and webpage 106 may have already been determined to be cacheable.

When a request for cached version 115 is received, cacheability engine 126 may look to timestamp 116 of the most recently cached version 115 and change rate 124 to determine whether or not the webpage is likely to have been changed by the current time of the request. For example, the request may have its own timestamp or the current system time may be determined. Then, for example, the age of cached version 115 may be determined based on the difference between the request timestamp or current time, and timestamp 116. The age may then be compared to change rate 124 to determine whether cached version 115 is fresh enough to be provided to a user (e.g., user device 110).

For example, if the age of cached version 115 is greater than change rate 124, then cached version 115 may be determined to be “too old” or likely to have changed, and therefore is not provided to user device 110. If, however, the age is less than change rate 124, cached version 115 may be provided to user device 110 as described herein. If the age is equal to change rate 124, then different embodiments may specify whether or not to provide cached version 115.

Cacheability engine 126 may make such a determination 128 in real-time. For example, after a request for cached version 115 is received, cacheability engine 126 may quickly determine whether or not to provide cached version 115.

If webpage 106 is not likely to have been changed by the time of the request, cacheability engine 126 may determine that cached version 115 has been captured recently enough to likely be identical or similar enough to a live version of webpage 106 as would be provided by webpage server 104. Cached version 115 may then be provided over network 108 for rendering on user device 110.

Subsequent requests or interactions with cached version 115 may then be directed to either webpage server 104 or cache system 102 depending on availability. For example, if webpage server 104 becomes available again, interactions with cached version 115 on user device 110, such as the selection of a hyperlink for another webpage 106, may be directed to webpage server 104.

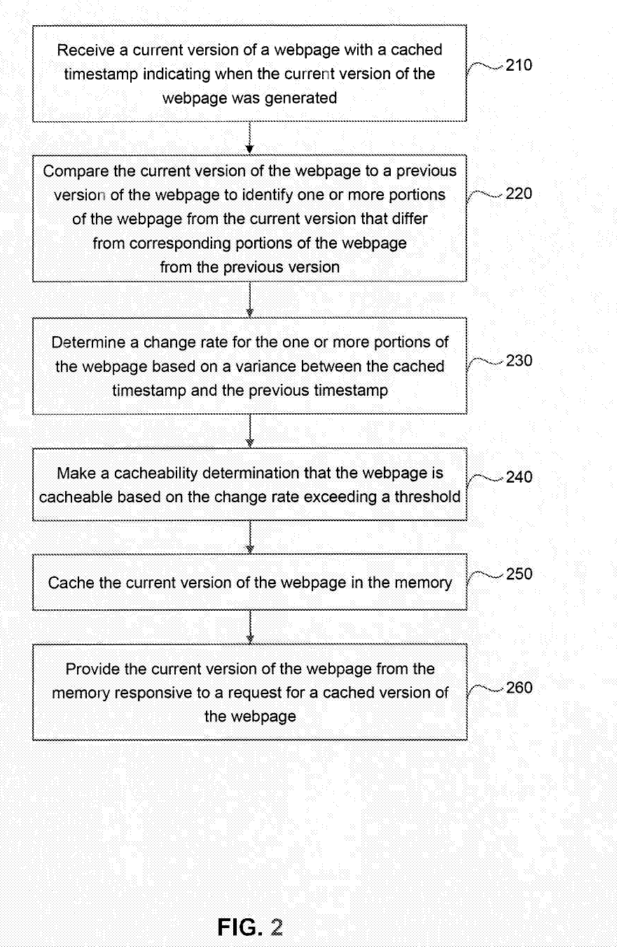

FIG. 2 is a flowchart of a method for determining the cacheability of a webpage and providing the cached webpage, according to an embodiment. The stages of FIG. 2 are described below, in non-limiting examples, with reference to FIG. 1.

At stage 210, a current version of a webpage with a current or cached timestamp indicating when the current version of the webpage was generated is received. For example, crawler 114 may request webpage 106 from webpage server 104 and receive webpage 106 over network 108. Crawler 114 may then assign timestamp 116 indicating when webpage 106 was requested, received, or generated.

At stage 220, the current version of the webpage is compared to a previously cached version of the webpage to identify one or more portions of the webpage from the current version that differ from corresponding portions of the webpage from the previously cached version. For example, comparator 120 may compare a current version of webpage 106 (which may be cached and stored as a cached or current version 115) to another previously cached version 115. The previously cached version 115 has an associated previous timestamp 116 indicating when the previously cached version 115 of webpage 106 was generated. Comparator 120 may determine whether there are changes between the current version 115 and the previously cached version 115. In an embodiment, comparator 120 may determine, more precisely, what changes exist between the current version 115 and the previously cached version 115.

One skilled in the art will recognize that current version 115 of webpage 106 may be a most recently cached or saved version of webpage 106, relative to previously cached version 115. For example, previously cached version 115 may be saved at a particular time, and then at a later time current version 115 may be captured. In some embodiments, the actual current or live version of webpage 106 as provided by webpage server 104 may differ from current version 115. For example, historical versions 115 of webpage 106 may be cached over a period of time, and compared to one another to determine change rate 124. Then if it is determined webpage 106 is cacheable, crawler 114 may continue to update or capture updated versions 115 of webpage 106.

Any methodology or feature(s) of the webpage may be used to compare two or more cached versions (e.g., 115). For example, a partial or full text or image comparison amongst different versions may be performed. The various versions may be hashed, and a comparison of the hash may be performed. Or, in an embodiment, a pixel-by-pixel comparison may be performed to determine what changes, if any, exist amongst the versions or portions thereof. One skilled in the art will recognize that while stage 220 is described as identifying differences amongst cached versions 115 of webpage 106, so too may similarities amongst cached versions 115 be identified.

At stage 230, a change rate for the one or more portions of the webpage is determined based on a variance between the cached timestamp and the previous timestamp. For example, rate determiner 122 may determine or calculate change rate 124 for webpage 106. In another embodiment, change rate 124 may be provided to cache system 102 by another system/device or determined from header 132. In an embodiment, change rate 124 is adjusted over time, as subsequent, additional and/or intermediately cached versions 115 of webpage 106 are received and processed.

At stage 240, a cacheability determination that the webpage is cacheable is made based on the change rate being within a threshold. For example, cacheability engine 126 may compare change rate 124 to threshold 130 to make determination 128 (e.g., cacheability determination) as to whether or not webpage 106 is cacheable. In an embodiment, cacheability engine 126 may use any factor, not limited to the comparison of change rate 124 and threshold 130, to make determination 128. For example, determination 128 may be based on an indication included in header 132 as to the cacheability of webpage 106, or whether personalized content 134 exists on webpage 106.

At stage 250, the current version of the webpage is cached in the memory as a currently cached version. For example, crawler 114 may cache or store webpage 106 in database 118 as cached version 115. Database 118 may include a correspondence between the webpage address of webpage 106, cached version 115, and determination 128 as may be indicated in list 136. In an embodiment, list 136 may be stored in database 118.

At stage 260, the currently cached version of the webpage is provided from the memory over the network responsive to a request for a cached version of the webpage. For example, cache system 102 may receive a request for webpage 106 or cached version 115 from user device 110, and may provide the most currently cached version 115 to user device 110 responsive to the request. In some embodiments, the most currently cached version 115 may differ from the version 115 used to determine change rate 124.

In some embodiments, prior to providing the most recently cached version 115 to user device 110, cacheability engine 126 may make sure that timestamp 116 and change rate 124 do not indicate that cached version 115 is likely to have changed by the current time or time of the request. If timestamp 116 and change rate 124 do indicate that cached version 115 is likely to have changed by the current time, the request may be redirected to webpage server 104 and cached version 115 may not be provided as being too old, out of date, or as being too likely to differ from the live version of webpage 106 as provided by webpage server 104. In an embodiment, in response to the request for the cached version of the webpage, cache system 102 may provide an indication or message that webpage 106 is not cacheable.

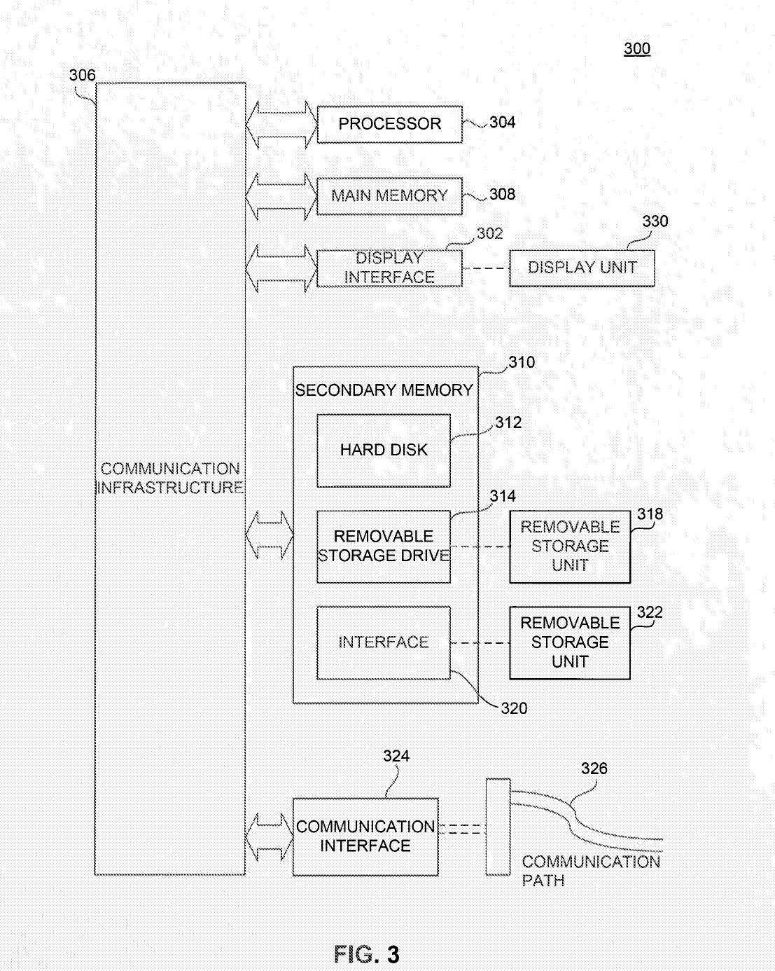

FIG. 3 illustrates an example computer system 300 in which embodiments as described herein, or portions thereof, may be implemented as computer-readable code. For example, cache system 102, and method 200, including portions thereof, may be implemented in computer system 300 using hardware, software, firmware, tangible computer readable media having instructions stored thereon, or a combination thereof, and may be implemented in one or more computer systems or other processing systems.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terms of this example computer system 300. After reading this description, it will become apparent to a person skilled in the relevant art how to implement the embodiments using other computer systems and/or computer architectures. Although some operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 304 may be a single processor in a multi-core/multiprocessor system, such system may be operating alone, or in a cluster of computing devices operating in a cluster or server farm. Processor device 304 is connected to a communication infrastructure 306, for example, a bus, message queue, network, or multi-core message-passing scheme.

Computer system 300 also includes a main memory 308, for example, random access memory (RAM), and may also include a secondary memory 310. Main memory 308 may include any kind of tangible memory. Secondary memory 310 may include, for example, a hard disk drive 312, and a removable storage drive 314. Removable storage drive 314 may include a floppy disk drive, a magnetic tape drive, an optical disk drive, a flash memory, or the like. The removable storage drive 314 reads from and/or writes to a removable storage unit 318 in a well-known manner. Removable storage unit 318 may include a floppy disk, magnetic tape, optical disk, etc. which is read by and written to by removable storage drive 314. As will be appreciated by persons skilled in the relevant art, removable storage unit 318 includes a computer readable storage medium having stored therein computer software and/or data.

Computer system 300 (optionally) includes a display interface 302 (which can include input and output devices such as keyboards (e.g., 104), mice, etc.) that forwards graphics, text, and other data from communication infrastructure 306 (or from a frame buffer not shown) for display on display unit 330.

In alternative implementations, secondary memory 310 may include other similar I/O ways for allowing computer programs or other instructions to be loaded into computer system 300, such as a removable storage unit 322 and an interface 320. Examples may include a program cartridge and cartridge interface (such as that found in video game devices), a removable memory chip (such as an EPROM (erasable programmable read only memory), or PROM) and associated socket, and other removable storage units 322 and interfaces 320 which allow software and data to be transferred from the removable storage unit 322 to computer system 300.

Computer system 300 may also include a communications interface 324.

Communications interface 324 allows software and data to be transferred between computer system 300 and external devices. Communications interface 324 may include a modem, a network interface (such as an Ethernet card), a communications port, a PCMCIA slot and card, or the like. Software and data transferred via communications interface 324 may be in the form of storage-incapable signals, which may be electronic, electromagnetic, optical, or other signals capable of being received by communications interface 324. These signals may be provided to communications interface 324 via a communications path 326. Communications path 326 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 318, removable storage unit 322, and a hard disk installed in hard disk drive 312. Computer storage medium and computer readable storage medium may also refer to memories, such as main memory 308 and secondary memory 310, which may be memory semiconductors (e.g. DRAMs (dynamic random access memory), etc.). Such mediums include non-transitory storage mediums.

Computer programs (also called computer control logic) are stored in main memory 308 and/or secondary memory 310. Computer programs may also be received via communications interface 324. Such computer programs, when executed, enable computer system 300 to implement embodiments as discussed herein. Where the embodiments are implemented using software, the software may be stored in a computer program product and loaded into computer system 300 using removable storage drive 314, interface 320, and hard disk drive 312, or communications interface 324.

Embodiments also may be directed to computer program products comprising software stored on any computer readable medium. Such software, when executed in one or more data processing device, causes a data processing device(s) to operate as described herein. Embodiments may employ any computer readable storage medium. Examples of computer readable storage mediums include, but are not limited to, primary storage devices (e.g., any type of random access memory), and secondary storage devices (e.g., hard drives, floppy disks, CD ROMS, ZIP disks, tapes, magnetic storage devices, and optical storage devices, MEMS (microelectromechanical systems), nanotechnological storage device, etc.).

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The Summary and Abstract sections may set forth one or more but not all exemplary embodiments contemplated, and thus, are not intended to limit the described embodiments or the appended claims in any way.

Various embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept as described herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described examples, but should be defined only in accordance with the following claims and their equivalents.

1. In at least one computer having at least one processor and one memory, a computer-implemented method, performed by the at least one processor, comprising:
receiving, over a network and from a device, a request for a webpage;
determining that a cached version of the webpage exists, the cached version including a cached timestamp indicating when the cached version was cached;
calculating a change rate associated with the webpage using a variance in time between a first time when a previously cached version of the webpage was retrieved and a second time when the cached version of the webpage was retrieved, the cached version of the webpage having been determined to differ from the previously cached version of the webpage prior to caching the cached version of the webpage, the change rate indicating how often one or more portions of the webpage change, and the change rate being independent of the device;
making a cacheability determination, responsive to receiving the request, as to whether the cached version of the webpage is to be provided responsive to the request based on the cached timestamp being more recent than the change rate being subtracted from one of a current time or time at which the request was received; and
when the cacheability determination indicates that the cached version of the webpage is to be provided, providing the cached version of the webpage responsive to the request, otherwise retrieving a current version of the webpage from a server, providing the current version of the webpage responsive to the request, and, when the current version of the webpage retrieved from the server differs from the cached version of the webpage, adjusting the change rate based on another variance between a third time when the current version of the webpage was retrieved from the server and the second time when the cached version was retrieved, otherwise not adjusting the change rate.

2. (canceled)

3. The method of claim 1, wherein the receiving comprises:
receiving the cached version of the webpage over the network from the server hosting the webpage prior to receiving the request, wherein the request comprises a request for the cached version of the webpage.

4. The method of claim 1, further comprising:
comparing a hash of the cached version of the webpage to a hash of the previously cached version of the webpage having a previous timestamp;
identifying, based on the comparing, one or more portions of the webpage from the cached version that differ from the previously cached version; and
determining the change rate for the one or more portions based on a difference between the cached timestamp and the previous timestamp.

5. The method of claim 1, further comprising:
comparing one or more pixels of the cached version of the webpage to one or more corresponding pixels of the previously cached version of the webpage having a previous timestamp;
identifying, based on the comparing, one or more portions of the webpage from the cached version that differ from the previously cached version; and
determining the change rate for the one or more portions based on a difference between the cached timestamp and the previous timestamp.

6. The method of claim 1, wherein the making the cacheability determination comprises:
determining that the webpage includes personalized content customized for a visitor to the webpage; and
making the cacheability determination that the webpage is not cacheable based on the determination that the webpage includes personalized content.

7. The method of claim 6, wherein the personalized content includes content customized based on a name, location, language, or social network of a user of the device.

8. The method of claim 1, further comprising:
storing code for generating the webpage in the memory, including text and images as provided in the cached version of the webpage.

9. The method of claim 1, further comprising:
determining that the current version of the webpage includes a multimedia file that exceeds a size threshold; and
caching the current version of the webpage as the cached version, wherein the cached version does not include the multimedia file that exceeds the size threshold.

10. The method of claim 1, further comprising:
making the cacheability determination that one or more portions of the webpage are not cacheable based on the change rate not being within a threshold.

11. The method of claim 1, further comprising:
comparing the cached version of the webpage and the previously cached version of the webpage having a previous timestamp to one or more other versions of the webpage, having one or more timestamps that differ from the previous timestamp and the cached timestamp;
determining, based on the comparing the cached version, the previously cached version and the one or more other versions, one or more portions of the webpage that differ between the cached version, the previously cached version, and the one or more other versions; and
determining the change rate for the one or more portions of the webpage based on a difference between corresponding timestamps for each portion of the webpage that differs from the other versions.

12. The method of claim 1, further comprising:
comparing the cached version of the webpage and the previously cached version of the webpage having a previous timestamp to an intermediate version of the webpage having an intermediate timestamp that is between the cached timestamp and the previous timestamp;
comparing the cached version of the webpage to the intermediate version of the webpage, wherein the one or more portions of the webpage from the cached version differ from corresponding portions of the webpage from the intermediate version; and
increasing the change rate based on a difference between the cached timestamp and the intermediate timestamp.

13. A non-transitory computer-readable storage medium storing instructions that when executed by a computing device cause the computing device to perform operations comprising:
determining a change rate for a webpage, wherein the change rate indicates a period of time during which one or more portions of the webpage remains constant and the change rate is calculated using a variance in time between when a current version of the webpage having a cached timestamp was retrieved from a server responsive to a request therefor and when a previous version of the webpage having a previous timestamp that is earlier than the cached timestamp was retrieved from the server responsive to another request therefor, the current version differing from the previous version;
making a cacheability determination, responsive to receiving the request for the webpage, whether the webpage is cacheable based on the change rate being within a threshold, wherein the cacheability determination indicates whether the webpage is cacheable; and
when the cacheability determination indicates that the webpage is cacheable:
caching the current version of the webpage in a memory as a currently cached version of the webpage, and
providing the currently cached version of the webpage from the memory over a network responsive to a request for a cached version of the webpage, wherein a difference between a request timestamp associated with the request and the cached timestamp is less than or equal to the change rate.

14. The computer-readable storage medium of claim 13, wherein the operations further comprise:
receiving, over the network, the current version of the webpage having the cached timestamp indicating when the current version of the webpage was received or generated;
comparing the current version of the webpage to the previous version of the webpage having the previous timestamp, wherein the previous timestamp indicates when the previous version of the webpage was received or generated; and
identifying, based on the comparing, one or more portions of the webpage from the current version that differ from corresponding portions of the webpage from the previous version.

15. The computer-readable storage medium of claim 13, wherein the making the cacheability determination comprises:
determining that the webpage includes an indication as to whether or not the webpage is cacheable; and
making the cacheability determination based on the indication of the webpage and whether the change rate is within the threshold.

16. The computer-readable storage medium of claim 13, wherein the making the cacheability determination comprises:
determining that the webpage includes personalized content customized for a visitor to the webpage; and
making the cacheability determination that the webpage is not cacheable based on the determination that the webpage includes personalized content.

17. The computer-readable storage medium of claim 13, wherein the providing comprises:
when the cacheability determination indicates that the webpage is not cacheable, providing, responsive to the request for the cached version of the webpage, an indication that the webpage is not cacheable.

18. A system comprising:
a processor;
a memory;
a crawler configured to receive, over a network, a current version of a webpage independent of any specific user request for the webpage, wherein the crawler is configured to assign the current version a cached timestamp;
a comparator configured to:
compare the current version of the webpage retrieved by the crawler independent of any specific user request to a previous version of the webpage retrieved by the crawler independent of any specific user request, the previous version having been assigned a previous timestamp by the crawler, the previous timestamp being earlier in time than the cached timestamp, and
determine one or more portions of the webpage from the current version that differ from corresponding portions of the webpage from the previous version;
a rate determiner configured to determine a change rate for the one or more portions of the webpage based on a variance between the cached timestamp corresponding to when the current version of the webpage was received by the crawler and the previous timestamp corresponding to when the previous version was received by the crawler; and
a cacheability engine configured to:
make a cacheability determination whether the webpage is cacheable based on the change rate being within a threshold, and
when the cacheability determination indicates that the webpage is cacheable:
cache the current version of the webpage in the memory as a currently cached version of the webpage, and
provide the currently cached version of the webpage from the memory over the network responsive to a request for a cached version of the webpage.

19. The system of claim 18, wherein the cacheability engine is further configured to:
determine that the webpage includes a header indicating that the webpage is not cacheable or that the webpage includes personalized content customized for a visitor to the webpage;
make the cacheability determination that the webpage is not cacheable based on either the header indication or the personalized content; and
provide an indication that the webpage is not cacheable responsive to the request for the cached version of the webpage.

20. The method of claim 1, wherein the cacheability determination is made prior to retrieving the current version of the webpage to determine whether the current version differs from the cached version of the webpage.

21. The system of claim 18, wherein the crawler is further configured to retrieve another version of the webpage independent of any specific user request for the webpage after a time period that is less than the variance elapses from the cached timestamp.

22. The system of claim 18, wherein the rate determiner is configured to determine the change rate based at least in part on the variance between the cached timestamp and the previous timestamp as well as another variance between the previous timestamp and another previous timestamp that corresponds to another version of the webpage that was received prior to the previous version of the webpage, the another version of the webpage differing from the previous version of the webpage.

23. The method of claim 1, wherein the webpage is associated with the change rate when the request is received and calculating the change rate associated with the webpage comprises:
responsive to determining that the cached version of the webpage differs from the previously cached version of the webpage, adjusting the change rate using the variance in time between the first time when the previously cached version of the webpage was retrieved and the second time when the cached version of the webpage was retrieved.
